(19) United States
(12) Patent Application Publication
(10) Pub. No.: US 2021/0110953 A1
(43) Pub. Date: Apr. 15, 2021

(54) CIRCUIT PROTECTION APPARATUS INCLUDING STRUCTURALLY RESILIENT ELECTRICAL TRANSIENT MATERIAL AND METHOD FOR MAKING SAME

(71) Applicant: Dongguan Littelfuse Electronics Company Limited, Dongguan City (CN)

(72) Inventors: Jianhua Chen, Dongguan City (CN); Chun-Kwan Tsang, Dongguan City (CN); Hao Cheng, Dongguan City (CN); Deepak Nayar, Dongguan City (CN)

(73) Assignee: Dongguan Littelfuse Electronics Company Limited, Dongguan City (CN)

(21) Appl. No.: 16/496,707

(22) PCT Filed: Mar. 31, 2017
(86) PCT No.: PCT/CN2017/078955

§ 371 Date: Sep. 23, 2019

(51) Int. Cl. H01C 7/12; H01B 1/22; H01B 1/24; H02H 9/00; H02H 9/04; H01C 7/10; H01C 17/065

(52) U.S. Cl. CPC H01C 7/12; H01B 1/22; H01B 1/24; H01C 17/0652; H02H 9/044; H01C 7/1006; H02H 9/005

(57) ABSTRACT

Structurally supported electrical transient materials are disclosed. Furthermore, methods to provide structurally supported electrical transient materials are disclosed. In one implementation, a structurally supported electrical transient material includes a support structure that is at least partially covered by an electrical transient material. In one example, the support structure is a mesh material integrated at least partially in the electrical transient material.

### BACKGROUND

### Field

The present invention relates generally to circuit protection apparatuses and methods for making circuit protection apparatuses. More particularly, the present invention relates to circuit protection apparatuses and methods for making the same, where the circuit protection apparatuses include electrical transient material, such as voltage variable material (VVM).

### Description of Related Art

Electrical transients produce high electric fields and usually high peak power that can render circuits or the highly sensitive electrical components in the circuits, temporarily or permanently non-functional. Electrical transients can include transient voltages capable of interrupting circuit operation or destroying the circuit outright. Electrical transients may arise, for example, from an electromagnetic pulse, an electrostatic discharge, lightning, a build-up of static electricity or be induced by the operation of other electronic or electrical components. An electrical transient can rise to its maximum amplitude in sub-nanosecond to microsecond times and have repeating amplitude peaks.

Materials exist for the protection against electrical transients, which are designed to respond very rapidly (ideally before the transient wave reaches its peak) to reduce the transmitted voltage to a much lower value for the duration of the electrical transients. Electrical transient materials are characterized by high electrical resistance values at low or normal operating voltages. In response to an electrical transient, the materials switch very rapidly to a low electrical resistance state. When the electrical transient dissipates, these materials return to their high resistance state. Electrical transient materials also recover very rapidly to their original high resistance value upon dissipation of the electrical transient.

Circuits, devices and apparatuses, such as a surge protection device, employing electrical transient materials can shunt a portion of the excessive voltage or current due to the electrical transient to ground, protecting the electrical circuit and its components. VVM may be used as electrical transient material in conventional circuit protection devices. Conventional VVM's have typically been of a consistency and composition requiring some form of housing or encapsulation that covers the VVM. This housing or encapsulation is used to prevent malfunction of the VVM, which may be caused by ambient moisture and/or contaminants (e.g., dust). However, use of the housing or encapsulation increases the cost of manufacturing conventional surge protection devices that use VVM. Furthermore, the housing or encapsulation may constrain manufacturing of miniaturized surge protection devices that use VVM.

Other problems with conventional surge protection devices will become apparent in view of the disclosure below.

### SUMMARY

Circuit protection devices and apparatuses that employ structurally resilient electrical transient material are disclosed. Methods for providing such circuit protection devices and apparatuses are also disclosed. In some implementations, the structurally resilient electrical transient material is a structurally resilient voltage variable material (VVM).

In some implementations, an apparatus may include a support structure, and an electrical transient material at least partially covering the support structure to thereby provide the support structure at least partially integrated in the electrical transient material.

In further implementations, a method may include providing a support structure, and at least partially covering the support structure with an electrical transient material to thereby provide the support structure at least partially integrated in the electrical transient material.

In yet further implementations, a circuit protection apparatus may include a support structure, an electrical transient material at least partially covering the support structure to thereby provide the support structure at least partially integrated in the electrical transient material, a first electrically conductive layer disposed over a first surface of the electrical transient material, and a second electrically conductive layer disposed over a second surface of the electrical transient material.

### BRIEF DESCRIPTION OF THE DRAWINGS

FIG. 1 illustrates an implementation of a structurally resilient electrical transient material, according to an embodiment of the disclosure.

FIG. 2 illustrates a cross-section view of the structurally resilient electrical transient material, as viewed from the perspective of line I-I shown in FIG. 1, according to an embodiment of the disclosure.

FIG. 3 illustrates an exemplary support structure that may be used to provide structural stability in the electrical transient material, according to an embodiment of the disclosure.

FIG. 4 illustrates another cross-section view of the structurally resilient electrical transient material, as viewed from the perspective of line I-I shown in FIG. 1, according to an embodiment of the disclosure.

FIG. 5 illustrates a circuit protection device or apparatus that comprises the structurally resilient electrical transient material, according to an embodiment of the disclosure.

FIG. 6 illustrates another a circuit protection device or apparatus that comprises the structurally resilient electrical transient material, according to an embodiment of the disclosure.

FIG. 7 illustrates an exemplary set of operations for manufacturing a circuit protection device or apparatus that comprises the structurally resilient electrical transient material, according to an embodiment of the disclosure.

### DETAILED DESCRIPTION

Circuit protection devices and apparatuses that employ structurally resilient electrical transient material are disclosed herein. Furthermore, methods to provide circuit protection devices and apparatuses that employ structurally resilient electrical transient material are disclosed herein. In some implementations, circuit protection devices and apparatuses employ structurally resilient electrical transient material that includes a support structure that is at least partially covered by an electrical transient material. In some implementations, the electrical transient material includes a binder material. The binder material may include therein a mixture of conductive and semi conductive particles. Furthermore, the binder material may include therein a mixture of insulative particles or nonconductive particles. In another example, the electrical transient material includes a binder material that comprises conductive and semi conductive particles. At least some of the conductive and semi conductive particles may be coated with an insulative oxide film.

In some implementations, the electrical transient material is a voltage variable material (VVM). In one example, the VVM includes an epoxy or resin material. The epoxy resin material may be a polymer-based material. The epoxy resin material may include particles. The particles may include: conductive particles (including core and shell conductive particles), insulating particles, semiconductive particles, doped semiconductive particles (including core and shell doped semiconductive particles) and any combination thereof.

The VVM may at least partially cover the support structure. In one example, the support structure is a mesh or lattice material. In another example, the support structure is at least one spacer material that includes a plurality of through holes, apertures, or through ways. In another example, the support structure is a plurality of single hole spacers. The holes or through ways of the aforementioned support structures may be square shaped, circular shaped, rectangle shaped, tetrahedral shaped, pyramidal shaped, triangular shaped, hexagon shaped, or the like.

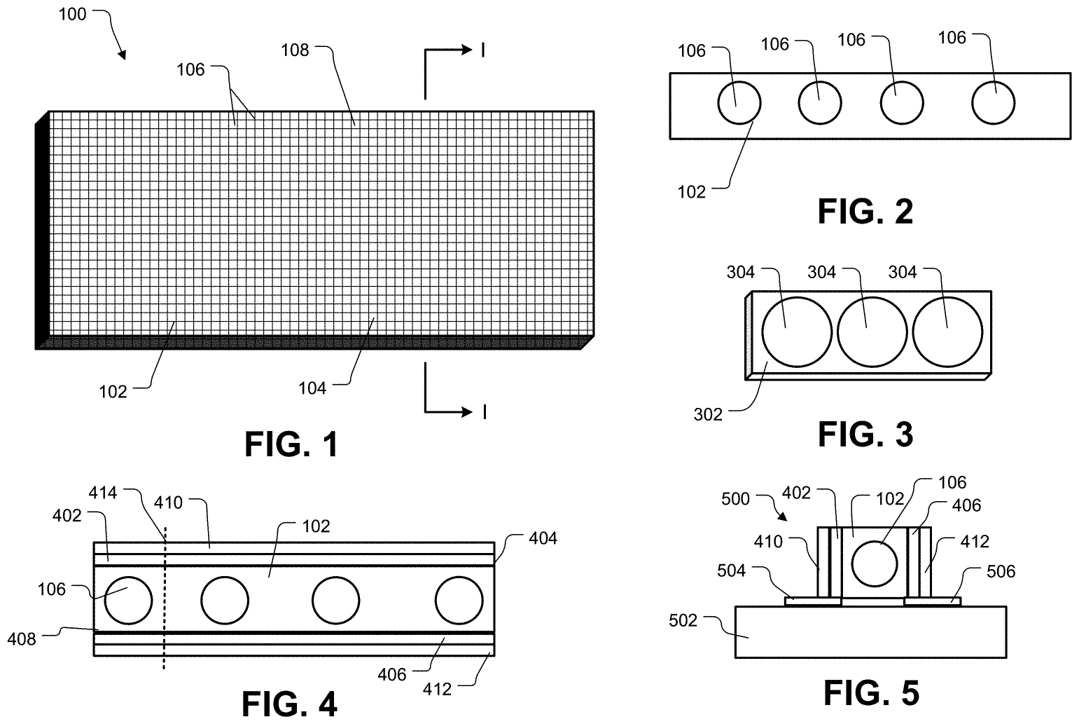

FIG. 1 illustrates an implementation of a structurally resilient electrical transient material 100. The structurally resilient electrical transient material 100 includes an electrical transient material 102 that at least partially covers a support structure 104. In some implementations, the electrical transient material 102 is VVM. At least partially covering the support structure 104 with the electrical transient material 102 provides at least a partially integrated structure. That is, the electrical transient material 102 may at least partially cover top and bottom surfaces of the support structure 104. In the example shown in FIG. 1, the support structure 104 is a mesh or lattice material. The support structure 104 may include strands 106 that define the mesh or lattice material of the support structure 104. More particularly, the strands 106 of the support structure 104 define a plurality of holes or apertures 108 of the support structure 104. The support structure 104 may alternatively be at least one spacer material (see FIG. 3) that includes a plurality of through holes, apertures or through ways, or the support structure 104 may be structured from a plurality of single hole spacers. The holes or through ways of the aforementioned support structure materials may be square shaped, circular shaped, rectangle shaped, tetrahedral shaped, pyramidal shaped, triangular shaped, hexagon shaped, or the like. The support structure 104 may alternatively have a different size and/or shape than illustrated and described herein. The structurally resilient electrical transient material 100 illustrated in FIG. 1 is shown as a sheet or film. However, the structurally resilient electrical transient material 100 may be provided in other shapes and sizes than that illustrated in FIG. 1.

The support structure 104 may be an electrically nonconductive material. For example, the support structure 104 may be glass, Kevlar, polymer, ceramic, carbon fiber, insulated metal, nonconductive material, fabric, or the like. Similarly, as discussed in the foregoing, the support structure 104 may comprise at least one spacer material (see FIG. 3) that includes a plurality of through holes, apertures or through ways, or the support structure 104 may be structured from a plurality of single hole spacers. The spacers defining the support structure 104 may comprise electrically nonconductive material.

The strands 106 of the support structure 104 may have a diameter of approximately 6 μm. However, the diameter of the strands 106 may be less than or greater than 6 μm. For example, the diameter of the strands 106 may be 1 mil. Alternatively, the diameter of the strands 106 may be 0.6 mil. The apertures 108 of the support structure 104 may have a width and/or length of at least 115 μm. In one example, at least one of the apertures 108 is defined by an opening of 115×145 μm. The size of the apertures 108 may be less than or greater than 115 μm. In one particular implementation, the support structure 104 has a material free open area of approximately 55% and a thermal stability of approximately 250° C. In some implementations, the free open area is between 1-95%. In addition, in some implementations, the support structure 104 is thermally stable at least up to a hardening temperature of the electrical transient material 102. Therefore, in one implementation, the support structure 104 resists melting, softening, and the like up to approximately 250° C. In one implementation, the support structure 104 is inert to organic solvents. Furthermore, the support structure 104 may have a compression strength capable of tolerating a force of approximately 150 kg/cm². In particular, the support structure 104 may be structurally stable up to at least a force of approximately 150 kg/cm². Therefore, the support structure 104 resists cracking, breaking, deformation, or the like up to at least a force of approximately 150 kg/cm². The support structure 104 may have a compression strength capable of tolerating a force of less than or greater than 150 kg/cm².

FIG. 2 illustrates a cross-section view of the structurally resilient electrical transient material 100, as viewed from the perspective of line I-I shown in FIG. 1. As is illustrated, the electrical transient material 102 at least partially covers one or more of the strands 106 associated with the support structure 104. Specifically, the electrical transient material 102 may not completely cover each of the strands 106. For example, an upper portion of one or more of the strands 106 may not be completely covered by electrical transient material 102. Moreover, lower and/or side portions of the strands 106 may not be completely covered by the electrical transient material 102. In one example, the electrical transient material 102 completely covers all the strands 106 or most of the strands 106. The strands 106 illustrated in FIG. 2 have a cross-section that is circular. However, other cross-sectional shapes, such as square or rectangle, may be associated with the strands 106.

FIG. 3 illustrates an exemplary support structure 302 that may be used to provide structural stability in the electrical transient material 102. The support structure 302 is an example of a spacer material that includes a plurality of through holes, apertures or through ways 304. The support structure 302 is shown as having three apertures 304. However, the illustrated number of apertures 304 is purely exemplary. The support structure 302 may be provided as a sheet or film that includes many of the apertures 304. Such a sheet or film may be integrated with the electrical transient material 102 to provide structural stability for electrical transient material 102. Alternatively, multiple separate support structures 302 may be combined together and integrated with the electrical transient material 102 to provide structural stability.

FIG. 4 illustrates yet another cross-section view of the structurally resilient electrical transient material 100, as viewed from the perspective of line I-I shown in FIG. 1. As is illustrated, the electrical transient material 102 at least partially covers one or more of the strands 106 associated with the support structure 104. In this embodiment, at least one electrically conductive layer 402 is applied over a first surface 404 of the structurally resilient electrical transient material 100. In the figure, the electrically conductive layer 402 is shown as being in contact with the electrical transient material 102. However, one or more layers may be disposed between the electrical transient material 102 and the electrically conductive layer 402. In another embodiment, another electrically conductive layer 406 is applied over a second surface 408 of the structurally resilient electrical transient material 100. In FIG. 4, the electrically conductive layer 406 is shown as being in contact with the electrical transient material 102. However, one or more layers may be disposed between the electrical transient material 102 and the electrically conductive layer 406. In some implementations, the electrically conductive layers 402 and 406 comprise copper (Cu). In some implementations, a layer 410 may be disposed over the layer 402. Moreover, in some implementations a layer 412 may be disposed over the layer 406. In some implementations, the layers of 410 and 412 comprise tin (Tn). The layer 410 may mitigate against oxide forming on the electrically conductive layer 402. Similarly, the layer 412 may mitigate against oxide forming on the electrically conductive layer 406. In some implementations, the layers 410 and 412 are made from an insulative material.

FIG. 5 illustrates a circuit protection device or apparatus 500 that comprises the structurally resilient electrical transient material 100. In some implementations, the circuit protection apparatus 500 is at least partially manufactured by cutting along a dashed line 414 (refer to FIG. 4). As illustrated in FIG. 5, the circuit protection apparatus 500 may be coupled to a printed circuit board (PCB) 502. The PCB 502 may include a first conductive pad 504 and the second conductive pad 506. At least the electrically conductive layer 402 may be coupled to the first conductive pad 504. Solder may be used to couple the electrically conductive layer 402 to the first conductive pad 504. Similarly, at least the electrically conductive layer 406 may be coupled to the second conductive pad 506. Solder may be used to couple the electrically conductive layer 406 to the second conductive pad 506.

In some implementations, the circuit protection apparatus 500 is coupled to the PCB 502 to protect one or more electrical components (not illustrated) associated with the PCB 502 from transient voltages capable of interrupting circuit operation or destroying the one or more electrical components. To that end, the structurally resilient electrical transient material 100 has a high electrical resistance value at low or normal operating voltages associated with the PCB 502. However, the structurally resilient electrical transient material 100 is functional to switch very rapidly to a low electrical resistance state when a transient voltage occurs. Therefore, the circuit protection apparatus 500 may be implemented on the PCB 502 in a manner that shunts transient voltages to ground, thereby protecting the one or more electrical components associated with the PCB 502.

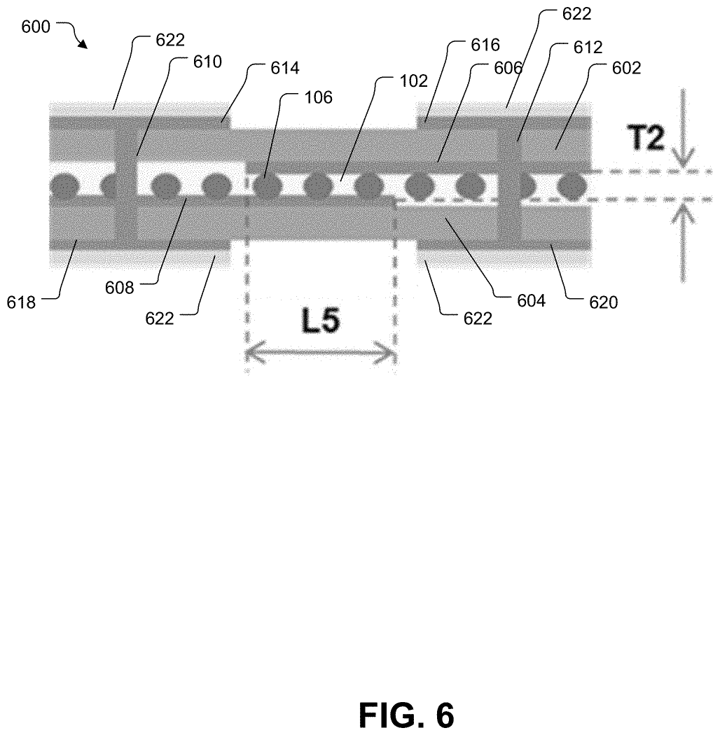

FIG. 6 illustrates a circuit protection device or apparatus 600 that comprises the structurally resilient electrical transient material 100. The circuit protection device apparatus 600 may include a first substrate 602 and a second substrate 604. The first and second substrate 602 and 604 may be FR-4 substrates, semi rigid substrates, or flexible substrates. The substrates 602 and 604 may be made from a polyamide material. The first substrate 602 may comprise a first electrode 606 coupled to at least a portion of a surface associated with the first substrate 602. The second substrate 604 may comprise a second electrode 608 coupled to at least a portion of a surface associated with the second substrate 604. The first electrode 606 and the second electrode 608 may be spaced apart by the structurally resilient electrical transient material 100. In some implementations, the first electrode 606 and the second electrode 608 are spaced apart by the electrical transient material 102 and the strands 106. The strands 106 may be disposed only between the first electrode 606 and the second electrode 608, or alternatively, as illustrated, the strands 106 may extend beyond the first electrode 606 and the second electrode 608. In some implementations, the illustrated gap T2 is approximately 6 μm. However, the illustrated gap T2 may be less than or greater than 6 μm. For example, illustrated gap T2 may be 1 mil. Alternatively, the illustrated gap T2 may be 0.6 mil. In some implementations, the illustrated length L5 is 0.2 mm. The illustrated length L5 may be between 0.15-0.25 mm.

In some implementations, the circuit protection apparatus 600 includes a first via 610 and a via 612. Cu may be disposed in the via 610. The Cu disposed in the via 610 is electrically coupled to the second electrode 608. Similarly, Cu may be disposed in the via 612. The Cu disposed in the via 612 is electrically coupled to the first electrode 606. Cu layers 614 and 616 may be disposed on a surface of the substrate 602. Similarly, Cu layers 618 and 620 may be disposed on a surface of the substrate 604. The layers and 614 and 618 may be electrically coupled by the Cu disposed in the via 610. Similarly, the layers 616 and 620 may be electrically coupled by the Cu disposed in the via 612. Tu 622 may be applied to the layers 614-620.

In some implementations, the circuit protection apparatus 600 may protect one or more electrical components (not illustrated) from transient voltages capable of interrupting circuit operation or destroying the one or more electrical components. To that end, the structurally resilient electrical transient material 100 has a high electrical resistance value at low or normal operating voltages. However, the structurally resilient electrical transient material 100 is functional to switch very rapidly to a low electrical resistance state when a transient voltage occurs. Therefore, the circuit protection apparatus 600 may be implemented on a PCB or the like in a manner that shunts transient voltages to ground, thereby protecting the one or more electrical components associated with the PCB.

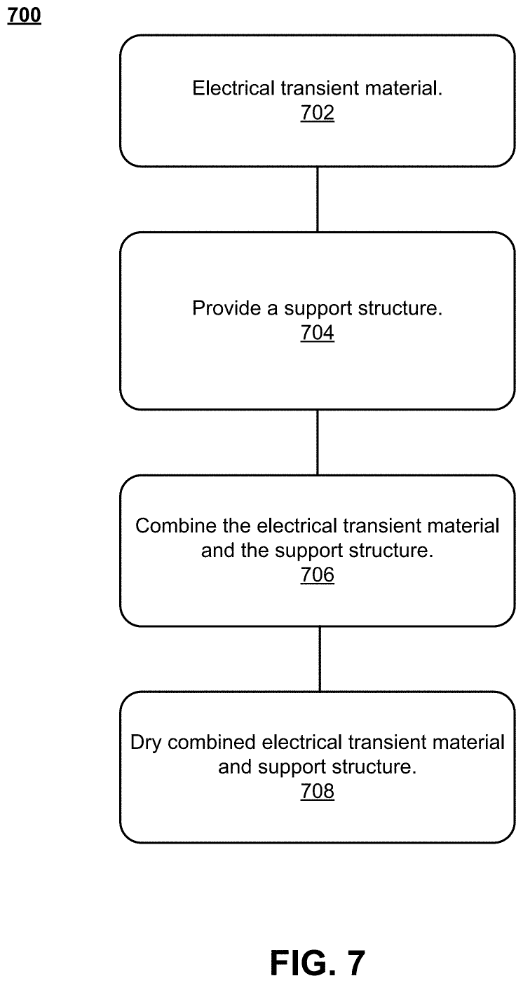

FIG. 7 illustrates an exemplary set of operations 700 for manufacturing a circuit protection device or apparatus 500/600 that comprises the structurally resilient electrical transient material 100. At block 702, an electrical transient material may be provided in a powdered form. Alternatively, the electrical transient material may be provided in a liquid form, also known as an electrical transient material ink. The electrical transient material may include one or more conductive and non-conductive particles. Furthermore, in some implementations, the electrical transient material may comprise polymer materials, including but not limited to epoxy resin.

At block 704, a support structure is provided. In one example, the support structure is a mesh or lattice material. In another example, the support structure is at least one spacer material that includes a plurality of through holes, apertures, or through ways. In another example, the support structure is a plurality of single hole spacers. The holes or through ways of the aforementioned support structure materials may be square shaped, circular shaped, rectangle shaped, tetrahedral shaped, pyramidal shaped, triangular shaped, hexagon shaped, or the like. The support structure may be an electrically nonconductive material. For example, the support structure may be glass, Kevlar, polymer, ceramic, carbon fiber, insulated metal, nonconductive material, fabric, or the like. In one example, one or more of the strands (e.g., strands 106) of the support structure may comprise electrically nonconductive material. Similarly, as discussed in the foregoing, the support structure may comprise at least one spacer material (see FIG. 3) that includes a plurality of through holes, apertures or through ways, or the support structure may be structured from a plurality of single hole spacers. The spacers defining the support structure may comprise electrically conductive material and/or electrically nonconductive material.

The strands 106 of the support structure 104 may have a diameter of approximately 6 μm. However, the diameter of the strands 106 may be less than or greater than 6 μm. For example, the diameter of the strands 106 may be 1 mil. Alternatively, the diameter of the strands 106 may be 0.6 mil. The apertures of the support structure may have a width and/or length of at least 115 μm. In one example, at least one of the apertures is defined by an opening of 115×145 μm. The size of the apertures may be less than or greater than 115 μm. In one particular implementation, the support structure has a material free open area of approximately 55% and a thermal stability of approximately 250° C. In some implementations, the free open area is between 1-95%. In addition, in some implementations, the support structure 104 is thermally stable at least up to a hardening temperature of the electrical transient material 102. In one implementation, the support structure is inert to organic solvents. Furthermore, support the structure may have a compression strength capable of tolerating a force of approximately 150 kg/cm². The support structure may have a compression strength capable of tolerating a force of less than or greater than 150 kg/cm².

At block 706, the electrical transient material and the support structure are combined. In one example, combining the electrical transient material and the support structure provides at least a partially integrated structure that includes the electrical transient material and the support structure in the electrical transient material. In one embodiment, the support structure is placed on a rigid surface, such as a conductive substrate or a plate, and the electrical transient material is applied over the support structure. Electrical transient material in powdered form may be sprayed over the support structure. Electrical transient material in ink form may also be sprayed over the support structure. Alternatively, electrical transient material in ink form may be applied over the support structure using an application blade. Electrical transient material in powdered form may be combined with the support structure by way of compression using a press or roll press to achieve a desired thickness of the structurally supported electrical transient material. Electrical transient material in ink form may be combined with the support structure using an application blade (e.g., Doctor Blade) to achieve a desired thickness of the structurally supported electrical transient material. In one or more embodiments, the process of combining the electrical transient material and the support structure may include providing one or more electrically conductive surface over a surface or surfaces of the structurally supported electrical transient material.

At block 708, the combined electrical transient material and support structure, which provide the structurally supported electrical transient material, is allowed to harden by drying, if necessary as part of the process of forming the structurally supported electrical transient material. In one implementation, the combined electrical transient material and support structure are hardened in an oven.

While structurally enhanced/supported electrical transient material and a method for manufacturing structurally enhanced/supported electrical transient material have been described with reference to certain embodiments, it will be understood by those skilled in the art that various changes may be made and equivalents may be substituted without departing from the spirit and scope of the claims of the application. Other modifications may be made to adapt a particular situation or material to the teachings disclosed above without departing from the scope of the claims. Therefore, the claims should not be construed as being limited to any one of the particular embodiments disclosed, but to any embodiments that fall within the scope of the claims.

We claim:

1. An apparatus, comprising:
a support structure; and
an electrical transient material at least partially covering the support structure to thereby provide the support structure at least partially integrated in the electrical transient material.

2. The apparatus according to claim 1, wherein the support structure comprises a mesh material, a multi-hole spacer, or a plurality of single hole spacers.

3. The apparatus according to claim 1, wherein the support structure comprises at least an electrically nonconductive material.

4. The apparatus according to claim 1, wherein the electrical transient material comprises a polymer resin, the polymer resin including conductive particles and nonconductive particles.

5. The apparatus according to claim 1, wherein the support structure comprises glass, Kevlar, polymer, ceramic, carbon fiber, insulated metal, nonconductive material or fabric.

6. The apparatus according to claim 1, wherein the support structure comprises a mesh material comprising a plurality of apertures and a plurality of strands defining the plurality of apertures, the electrical transient material at least partially filling one or more of the plurality of apertures and at least partially covering one or more of the plurality of strands.

7. The apparatus according to claim 6, wherein each of the plurality of strands have a diameter of at least 6 μm.

8. The apparatus according to claim 6, wherein the mesh material comprises a free open area of approximately 55% and a thermal stability of approximately 250 degrees Celsius.

9. The apparatus according to claim 1, wherein the support structure is structurally stable up to a force of approximately 150 kg/cm² and thermally stable up approximately 250 degrees Celsius.

10. The apparatus according to claim 1, wherein the electrical transient material at least partially covering the support structure comprises first and second opposite surfaces, and comprising an electrically conductive layer disposed over at least one of the first and second opposite surfaces.

11. The apparatus according to claim 1, wherein the electrical transient material is a voltage variable material (VVM).

12. A method, comprising:
providing a support structure; and
at least partially covering the support structure with an electrical transient material to thereby provide the support structure at least partially integrated in the electrical transient material.

13. The method according to claim 12, wherein the support structure comprises a mesh material, a multi-hole spacer, or a plurality of single hole spacers.

14. The method according to claim 12, wherein the support structure comprises glass, Kevlar, polymer, ceramic, carbon fiber, insulated metal, nonconductive material or fabric.

15. The method according to claim 12, wherein the support structure comprises a mesh material comprising a plurality of apertures and a plurality of strands defining the plurality of apertures, the electrical transient material at least partially filling one or more of the plurality of apertures and at least partially covering one or more of the plurality of strands.

16. A circuit protection apparatus, comprising:
a support structure;
an electrical transient material at least partially covering the support structure to thereby provide the support structure at least partially integrated in the electrical transient material;
a first electrically conductive layer disposed over a first surface of the electrical transient material; and
a second electrically conductive layer disposed over a second surface of the electrical transient material.

17. The circuit protection apparatus according to claim 16, wherein the electrical transient material is a voltage variable material (VVM).

18. The circuit protection apparatus according to claim 16, wherein the support structure comprises a mesh material, a multi-hole spacer, or a plurality of single hole spacers.

19. The circuit protection apparatus according to claim 16, wherein the support structure comprises a mesh material comprising a plurality of apertures and a plurality of strands defining the plurality of apertures, the electrical transient material at least partially filling one or more of the plurality of apertures and at least partially covering one or more of the plurality of strands.
